(19) United States
(12) Patent Application Publication
(10) Pub. No.: US 2002/0040306 A1
(43) Pub. Date: Apr. 4, 2002

(54) Method and system for selling and buying insurance for damages caused by the internet-related activities

(76) Inventors: Kazuhiko Sugiyama, Tokyo (JP); Masayoshi Ogata, Tokyo (JP); Akihiro Nishibashi, Tokyo (JP)

Correspondence Address: KNOBLE & YOSHIDA, LLC, Eight Penn Center, Suite 1350, 1628 John F. Kennedy Blvd., Philadelphia, PA, 19103, US

(21) Appl. No.: 09/817,485

(22) Filed: Mar. 26, 2001

(30) Foreign Application Priority Data
Sep. 29, 2000 (JP) 2000-299990

(51) Int. Cl. G06F 17/60

(52) U.S. Cl. 705/4

(57) ABSTRACT

The Internet-related activities have caused some significant damage to a computer system. One type of the damage is generally related to the destruction or mutilation of computer files that contain a program, data or other information. One cause is computer virus programs that undesirably cause the above described damage. To insure such damage, the on-line insurance transactional system and method according to the current invention have been described.

### FIELD OF THE INVENTION

The current invention is generally related to a method and a system for selling insurance, and more particularly related to a method and a system for selling insurance for damages caused by the Internet-related activities.

### BACKGROUND OF THE INVENTION

Referring to FIG. 1, to obtain information, the Internet has become a popular source. In general, to search certain information, a user initially establishes a connection between a particular user site 101 and the Internet 105. Furthermore, the user gains via the Internet 105 access to a certain search site 1002, where a search service is available. The search site 1002 has access via the Internet 105 to a variety of information sources or homes pages 110 including web magazine sites 1101, specialized sites 1104, membership sites 1102 and free sites 1103. The home pages 110 are usually a file on the World Wide Web and each contain information in the Hyper Text Markup Language (HTML). To obtain desired information, the user searches relevant home pages by specifying a key word at the search site 1002. The key word includes a combination of words or an address such as Universal Resource Locator (URL) of a particular home page. The information on the searched web sites or home pages is transferred to the user site 101 for display. The Internet, thus, allows the user site to transfer the data to and from these files at the web sites.

Now referring to FIG. 2, a timing chart illustrates an exemplary prior art sequence of events that are involved in searching information in the Internet. The user site 101 accesses the search site 1002. In response to the search site access request, the search site 1002 transmits a predetermined search input screen back to the user site 101. At the user site 101, an input screen 111 now displays an input area where a user inputs search key information such as words or URL's. In response to a start command at the user site 101, the inputted search key information is first transmitted to the search site 1002, and the search site 1002 commences a search among home pages 110 based upon the search key. Home pages that met the search criterion are considered as “hits,” and the relevant information such as a number of hits, each URL and a title is returned to the search site 1002 and then to the original user site 101. The search results are shown on the first output screen 112. For example, the search results are shown as a list of home pages with short description. The user selects a certain home page for further details, and the selected home page is contacted via the search site 1002. The detailed information from the selected home page is displayed in the second output screen 113 at the user site 101.

Referring back to FIG. 1, the Internet also allows the information transfer between the user sites through e-mail. For example, a first user at the user site No1 101 writes e-mail to a second user at the user site No 2 101A. The information is placed in a predetermined e-mail file according to a predetermined transfer protocol at the first user site 101 and is addressed to the second user site 101A. The e-mail file is transferred to the intended user site via the Internet 105.

During the course of the above described Internet-related activities, certain information is downloaded from a web site to a user site or certain other information is transferred between the user sites. It is known that these Internet-related activities are associated with a finite amount of risk for undesirably damaging computer files. Computer programs that are categorized as a virus generally cause damage to computer files. The virus programs are unknowingly transferred from an infected computer file to another while information is downloaded from a web site or transferred in e-mail. Another risk is associated with the use of a search engine or site where the search target areas are defined by the search site itself. The user of the search site generally does not have a control over the scope of the search areas or home pages. Although it is rare that a publicly available search engine searches web sites that are not publicly accessible, it is possible that a certain search engine searches an unintended or non-public web sites. For this reason, an unrestricted search is a risk. Because of the above described possibilities, the potential risk that is associated with the Internet-related activities should be managed.

### SUMMARY OF THE INVENTION

In order to solve the above and other problems, according to a first aspect of the current invention, a method of selling and buying insurance for damages to computer files caused by the Internet activities, including: selecting at least one activity from a set of predetermined activities on the Internet for insurance coverage, the predetermined activities bearing a certain risk of causing damage to the computer files; selecting an insurance coverage amount from a set of predetermined amounts for the selected Internet activities; calculating a premium amount for an insurance purchaser based upon at least a combination of the selected insurance coverage amount and the selected Internet activities; and submitting the premium to an insurance provider.

According to a second aspect of the current invention, a system for selling and buying insurance for damages to computer files caused by the Internet activities, including: a first user input module for selecting at least one activity from a set of predetermined activities on the Internet for insurance coverage, the predetermined activities bearing a certain risk of causing damage to the computer files; a second user input module for selecting an insurance coverage amount from a set of predetermined amounts for the selected Internet activities; a processing module connected to the first user input module and the second user input module for calculating a premium amount for an insurance purchaser based upon at least a combination of the selected insurance coverage amount and the selected Internet activities; and a premium payment module for connected to the processing module for submitting the premium to an insurance provider.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagram illustrating the prior art use of the Internet to search certain information.

FIG. 2 is a timing chart illustrating an exemplary prior art sequence of events that are involved in searching information in the Internet.

FIG. 3 is a flow chart illustrating acts involved in a preferred process of selling and buying insurance for damage caused by the Internet-related activities according to the current invention.

FIG. 4 is a diagram illustrating one preferred embodiment of the Internet-related insurance transaction system according to the current invention.

FIG. 5 is a diagram illustrating a second preferred embodiment of the on-line search insurance transaction system according to the current invention.

FIG. 6 is a timing chart illustrating an exemplary sequence of events that are performed by the second preferred embodiment according to the current invention.

FIG. 7 is a diagram illustrating an alternative embodiment of the second preferred embodiment of the on-line search insurance transaction system according to the current invention.

FIG. 8 is a timing chart illustrating another exemplary sequence of events that are performed by the second preferred embodiment according to the current invention.

FIG. 9 is a diagram illustrating an exemplary user interface of one preferred embodiment of the Internet-related damage insurance transaction system according to the current invention.

FIG. 10 is a diagram illustrating an exemplary user interface for the search result of one preferred embodiment of the Internet-related damage insurance transaction system according to the current invention.

FIG. 11 is a diagram illustrating an exemplary user interface for the search result list of one preferred embodiment of the Internet-related damage insurance transaction system according to the current invention.

FIG. 12 is a diagram illustrating an exemplary user management table for one preferred embodiment of the Internet-related damage insurance transaction system according to the current invention.

FIG. 13 is a diagram illustrating an exemplary individual user table for one preferred embodiment of the Internet-related damage insurance transaction system according to the current invention.

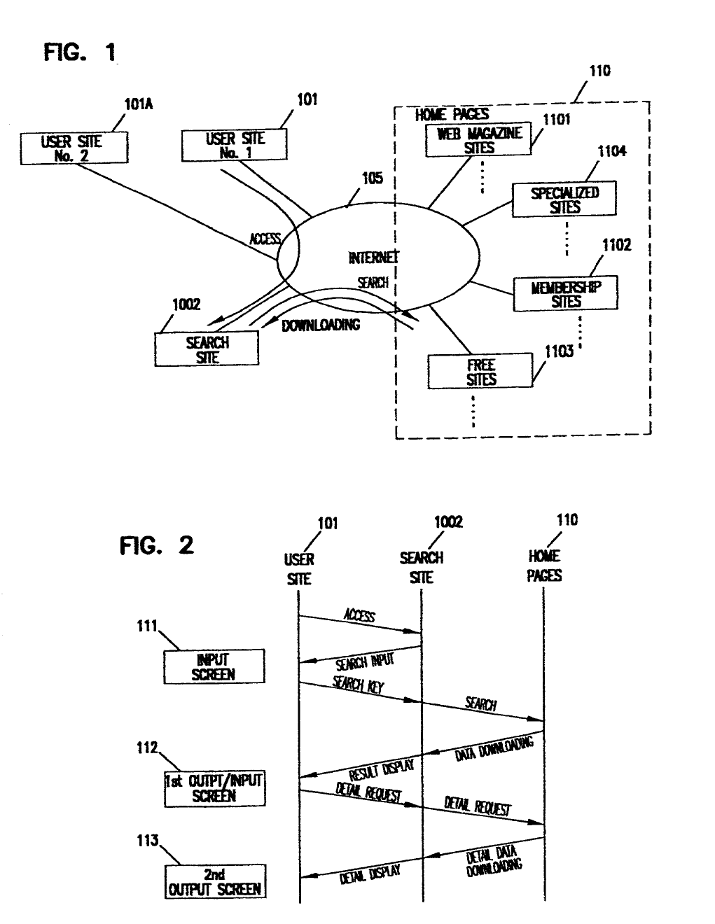

### DETAILED DESCRIPTION OF THE PREFERRED EMBODIMENT(S)

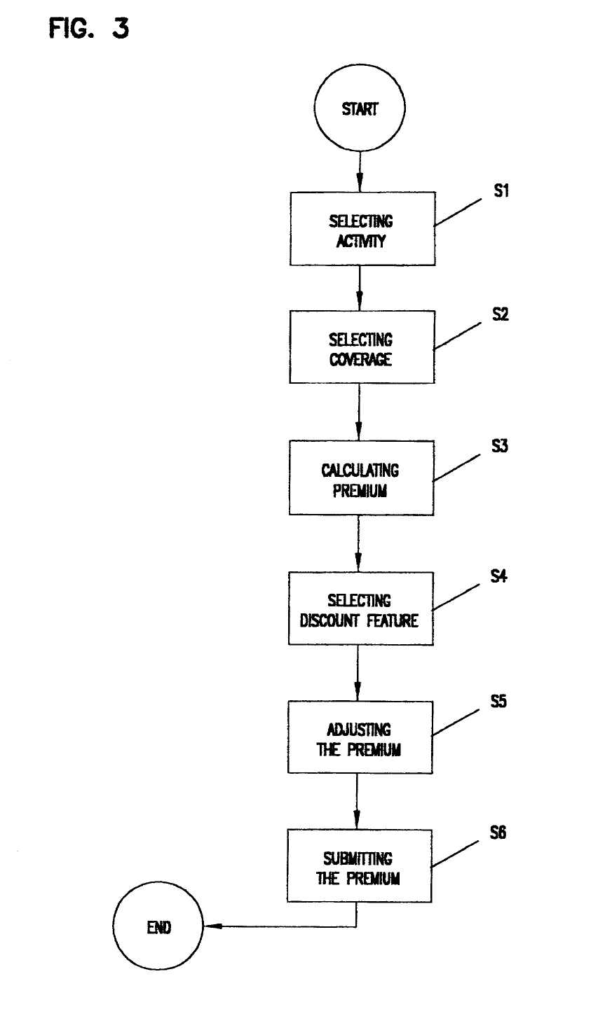

Referring now to the drawings, wherein like reference numerals designate corresponding structures throughout the views, and referring in particular to FIG. 3, a flow chart illustrate acts involved in a preferred process of selling and buying insurance for damage caused by the Internet-related activities according to the current invention. A consumer or an insurance purchaser first selects what activities are to be insured in step S1. One way to make the selection is to display a set of predetermined activities that an insurance provider offers coverage, and the insurance purchaser selects any combination of the activities to be covered by the insurance. One exemplary predetermined activities include down-loading a file, information or data from a web site, opening e-mail, opening e-mail attachments, searching information from web sites and copying a file from a secondary storage medium. Any of these predetermined activities is potentially risky in unknowingly transferring a destructive computer virus program. Some of the search activities are also potentially risky in obtaining information that is not necessary publicly posted.

Still referring to FIG. 3, the preferred process further proceeds to determine the terms of the insurance purchase according to the current invention. Once the insured activity is determined in the step S1, the insurance purchaser selects a maximal amount of insured coverage in step S2. When damage occurs to due the selected insured activities, the insurance provider is liable for the damage up to the maximal coverage amount that is specified in the step S2. Based upon a combination of at least the selected insured activities and the maximal coverage amount, the preferred process now determines an insurance premium amount in step S3. In addition to the above described two factors, the preferred process may further include other factors such as a frequency of the selected Internet-related activities in order to determine the insurance premium amount. The preferred process then asks the insurance purchaser to select any discount feature from a set of predetermined conditions such as the use of an anti-virus program and fire walls on a subject computer system. The insurance purchaser selects any of the discount conditions in step S4 and later will submit a proof of the discounted features to the insurance provider. Based upon the selected discounted features, the preferred process adjusts the previously determined insurance premium in step S5. Although the premium determination steps include the initial determination and the subsequent adjustment in the above described preferred process, an alternative process combines these two separate steps. Finally, after the premium is adjusted according to the discount features, the insurance purchaser submits the adjusted insurance premium to the insurance provider in step S6. The submission methods include a secured on-line transaction by using a credit card as well as a check tender via mail. Thus, the insurance purchase is confirmed.

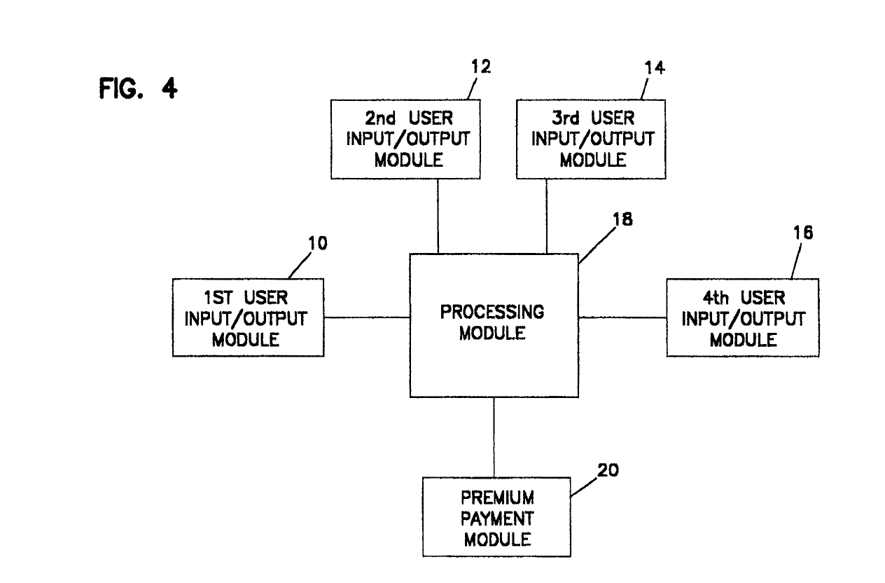

Now referring to FIG. 4, a diagram illustrates one preferred embodiment of the Internet-related insurance transaction system according to the current invention. The Internet-related insurance transaction system includes a first user input/output module 10, a second user input/output module 12, a third user input/output module 14, a fourth user input/output module 16, a processing module 18 and a premium payment module 20. The first input/output module 10 displays an insurance purchaser a set of predetermined activities that an insurance provider offers for insurance coverage. One exemplary predetermined activities include down-loading a file, information or data from a web site, opening e-mail, opening e-mail attachments, searching information from web sites and copying a file from a secondary storage medium. Any of these predetermined activities is potentially risky in unknowingly transferring a destructive computer virus program. Some of the search activities are also potentially risky in obtaining information that is not necessary publicly posted. The insurance purchaser selects the activities to be covered and inputs the selected activities on the first input/output module 10. The second input/output module 12 displays an insurance purchaser a set of predetermined coverage amounts that an insurance provider offers for the Internet insurance. According to the preferred embodiment, the insurance purchaser selects the coverage amount for each of the selected insured activities and inputs the maximal coverage amount in the second input/output module 12.

Still referring to FIG. 4, based upon the information inputted through the first and second input/output modules 10 and 12, the processing module 18 determines an insurance premium amount in the preferred embodiment. The processing module 18 outputs the insurance premium amount to the second user input/output module. Optionally, in the preferred embodiment of the insurance on-line transaction system according to the current invention, the third user input/output module 14 allows the insurance purchaser to specify certain conditions for discounting the insurance premium. The third user input/output module 14 displays a set of predetermined conditions that help reduce the risk of having damage due to the specified Internet-related activities. One exemplary discount condition is the use of an anti-virus program. Based upon the conditions that are specified in the third user input/output module 14, the processing module 18 adjusts the already calculated insurance premium, and the third user input/output module 14 displays the adjusted insurance premium. The premium payment module 20 enables the insurance purchaser to submit the adjusted premium on line. The premium payment module 20 securely transacts credit card information to the insurance provider. Lastly, when the damage occurs due to the insured Internet-related activities, the fourth user input/output module enables the insured to submit a damage report to the insurance provider.

Now referring to FIG. 5, a diagram illustrates a second preferred embodiment of the on-line search insurance transaction system according to the current invention. The preferred embodiment includes a user site 101, a search site 102, an insurance provider site 103 and home pages 110 that are connected via the Internet 105. In general, to search certain information, a user initially establishes a connection between a particular user site 101 and the Internet 105. Furthermore, the user gains via the Internet 105 access to a certain search site 102, where a search service is available. The search site 102 has access via the Internet 105 to a variety of information sources or homes pages 110 including web magazine sites 1101, specialized sites 1104, membership sites 1102 and free sites 1103. The home pages 110 are usually a file on the World Wide Web and each contain information in the Hyper Text Markup Language (HTML). To obtain desired information, the user searches relevant home pages by specifying a key word and an information source at the search site 102. The key word includes a combination of words or an address such as Universal Resource Locator (URL) of a particular home page. The information on the searched web sites or home pages is transferred to the user site 101 for display. The Internet, thus, allows the user site to transfer the data to and from these files at the web sites.

Still referring to FIG. 5, the search site 102 also has access via the Internet 105 to the insurance provider site 103. Before the search starts, in response to an inquiry from the search site 102, the insurance provider site 103 offers insurance data to the search site 102 based upon the selected key word and information source. The insurance data includes an insurance premium for the selected search activity, and the user determines whether or not to take the search insurance at the user site 101. As described above, the search insurance generally covers damage associated with a particular search activity. In an alternative embodiment, the insurance premium is an estimate before the specified search is conducted since an actual number of search transactions cannot be exactly determined. Upon receiving the confirmation at the insurance site 103 from the user site 101, the specified search is performed. Upon completing the requested search, the search site 102 transmits the search results to the user site 101 for display. In addition, if the user has accepted the estimated search insurance premium, the insurance provider site 103 confirms the exact insurance premium cost.

Now referring to FIG. 6, a timing chart illustrates an exemplary sequence of events that are performed by the second preferred embodiment according to the current invention. Initially, the search site 102 receives insurance data from the insurance site 103 in step S300. The insurance data includes insurance premiums or search insurance fees based upon search categories including free information, membership-required information and so on. The user site 101 accesses the search site 102 in step S301. In response to the search site access request, the search site 102 transmits a predetermined search input screen back to the user site 101 in step S302. At the user site 101, a first input screen 31 now displays an input area where a user inputs search key information such as words or URL's as well as an insurance purchase area where the user specifies the insurance purchase information. The user inputs the relevant search and or insurance information in the first input screen 31 in step S303. In response to the above input information, the search site 102 now calculates the insurance premium amount for the specified search request and displays the calculated data on a second input screen at the user site 101 in step S304. One preferred sequence requires that the user should indicate the acceptance of the proposed insurance premium by issuing a start command in step 305. When the user issues the start command at the user site 101 in the step S305, the inputted search key information is first transmitted to the search site 102, and the search site 102 commences a search among home pages 110 based upon the specified search key in step S306. Home pages that met the search criterion are considered as “hits,” and the relevant information such as a number of hits, each URL and a title is returned in step S307 to the search site 102 and then to the original user site 101 in step S309. The search results are shown on the first output screen 33. For example, the search results are shown as a list of home pages with short description. The user selects a certain home page for further details in step S310, and the selected home page is retrieved via the search site 102 also in step S311. The detailed information from the selected home page is displayed in the second output screen 34 at the user site 101 in step S313.

Still referring to FIG. 6, an alternative sequence of the second preferred embodiment according to the current invention includes the insurance application procedure. In lieu of accepting the insurance premium in the step 305, the alternative sequence requires that the insurance premium be charged in step 312 for each of the detailed information retrieval in step S311 from a selected home page after a list of searched home pages is displayed.

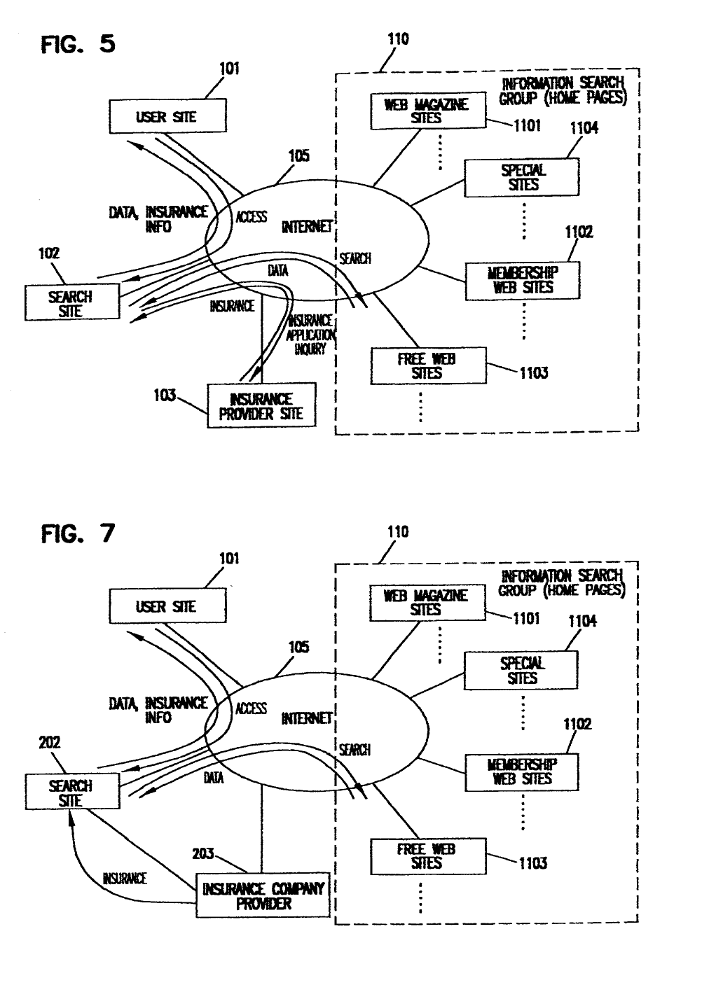

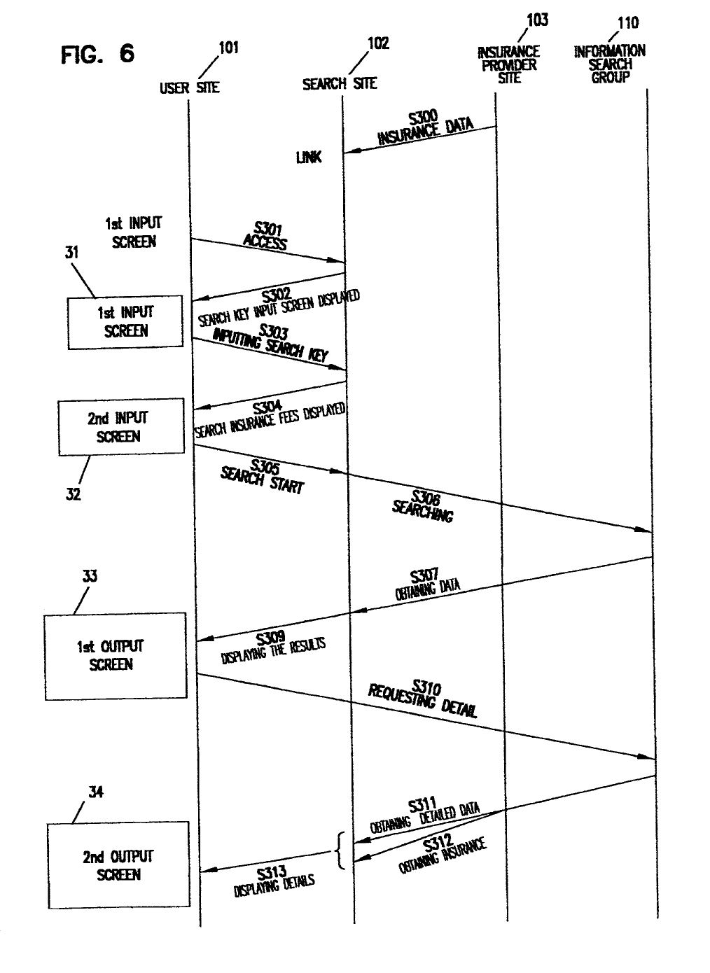

Now referring to FIG. 7, a diagram illustrates an alternative embodiment of the second preferred embodiment of the on-line search insurance transaction system according to the current invention. The preferred embodiment includes a user site 101, a search site 202 and home pages 110 that are connected via the Internet 105. An insurance provider 203 is not necessarily connected to the Internet 105, but there is an agreement between the insurance provider 203 and the search site 202. In general, to search certain information, a user initially establishes a connection between a particular user site 101 and the Internet 105. Furthermore, the user gains via the Internet 105 access to a certain search site 202, where a search service is available. The search site 202 has access via the Internet 105 to a variety of information sources or homes pages 110 including web magazine sites 1101, specialized sites 1104, membership sites 1102 and free sites 1103. The home pages 110 are usually a file on the World Wide Web and each contain information in the Hyper Text Markup Language (HTML). To obtain desired information, the user searches relevant home pages by specifying a key word and an information source at the search site 202. The key word includes a combination of words or an address such as Universal Resource Locator (URL) of a particular home page. The information on the searched web sites or home pages is transferred to the user site 101 for display. The Internet, thus, allows the user site to transfer the data to and from these files at the web sites.

Still referring to FIG. 7, the search site 202 also displays information on the insurance provider site 103 before the search starts without downloading any information from another site. One type of the information display contains the agreed terms of the search insurance sales between the search site 202 and the insurance company 203. The information includes an insurance premium amount for a specific search area or a specific source of information based upon the selected key word and information source. The user determines whether or not to take the search insurance at the user site 101. As described above, the search insurance generally covers damage associated with a particular search activity. In an alternative embodiment, the insurance premium is an estimate before the specified search is conducted since an actual number of search transactions cannot be exactly determined. Upon receiving the confirmation for insurance acceptance at the user site 101, the specified search is performed. Upon completing the requested search, the search site 202 transmits the search results to the user site 101 for display. In addition, if the user has accepted the estimated search insurance premium, the search site 202 confirms the exact insurance premium cost.

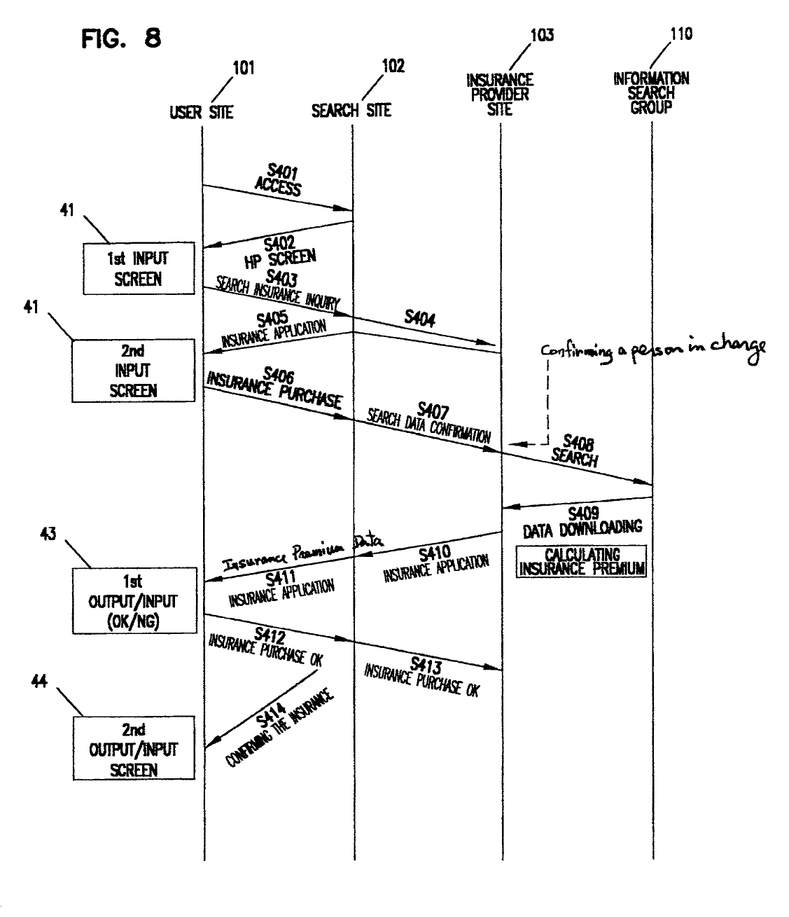

Now referring to FIG. 8, a timing chart illustrates another exemplary sequence of events that are performed by the second preferred embodiment according to the current invention. Initially, the search site 102 already contains the insurance data that has been previously agreed by the insurance company 103. The insurance data includes insurance premiums or search insurance fees based upon search categories including free information, membership-required information and so on. The user site 101 accesses the search site 102 in step S401. In response to the search site access request, the search site 102 transmits a predetermined search input screen back to the user site 101 in step S402. At the user site 101, a first input screen 41 now displays the insurance information. In response to an insurance inquiry on the first input screen 41 in step 403, the insurance application information is retrieved from the insurance site 102 and outputted to the second input screen 42 in step 405. In response to the inquiry, the search site 102 notifies the insurance site 103 for preparing the corresponding insurance terms in step S404.

Still referring to FIG. 8, at the user site 101, a second input screen 42 now also displays an input area where a user inputs search key information such as words or URL's. The user inputs the relevant search and or insurance information in the second input screen 42 to initiate a search in step S406. In response to the above input information, the search site 102 now initiates a simulated or simplified search based upon the specified search information in steps S407 and 408 in order to calculate the insurance premium amount for the specified search request in step S409. The insurance site 103 sends the calculated data to the search site 102 in step S410 and displays on a first input/output screen 43 at the user site 101 in step S411. One preferred sequence requires that the user should indicate the acceptance of the proposed insurance premium by issuing a confirmation command in step 412. When the user issues the insurance acceptance command at the user site 101 in the step S412, the search site 102 sends the acceptance information to the insurance site 103. The search site 102 further sends the confirmation back to the second output/input screen 44 at the user site 101.

Optionally, the above described alternative embodiment has an additional feature of repeating the specified search on a predetermined periodic basis. For example, the search site 102 initiates the specified search based upon the keyword, “Hitachi Kokusai Electric and new products” every week for one year using all web sites including membership sites. The search site 102 then reports the search results to the user site 101 as each periodic search is completed. For this exemplary periodic arrangement, the corresponding search fees and the insurance premium are charged to the user and paid to the insurance site 103.

Now referring to FIG. 9, a diagram illustrates an exemplary user interface of one preferred embodiment of the Internet-related damage insurance transaction system according to the current invention. The exemplary user interface includes a search key area 200, a search information sources area 208, an insurance specification area 228, a maximal insurance/search fee area 220, a start key area 230 and an insurance/search fee area 232. The user specifies the search information by entering key words in the search key entry areas 202, 204 and 206. Any combination of these entered key words is used for a search. To specify the search area or web sites, the user clicks a desired set of web site sources that correspond home pates 210, e-mail magazines 212, specialized sites 214, membership sites 216 and all of the above sites 218. The insurance specification area 228 has a corresponding area to specify insurance for the specified search area. For the specified search keys, information sources and insurance, the user specifies a maximal amount of fees in the maximal insurance/search fee area 200 that he or she will pay upon completing the requested search. Based upon the above specified information, the user initiates the search by pressing the start key 230. The start key 230 also initiates the insurance application process at a predetermined insurance site based upon the specified insurance information and the calculated insurance premium and the search fee are displayed in the corresponding insurance fee display area 236 and search fee display area 234.

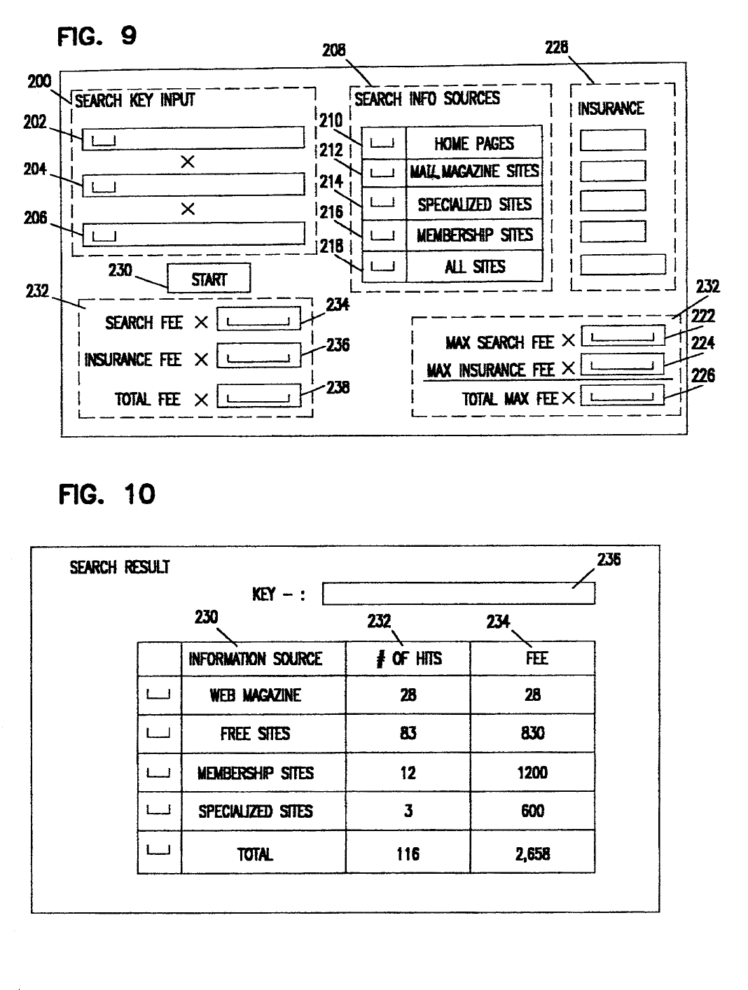

Referring to FIG. 10, a diagram illustrates an exemplary user interface for the search result of one preferred embodiment of the Internet-related damage insurance transaction system according to the current invention. The exemplary user interface includes an information source display area 230, a number of hits display area 232, a fee display area 234 and a used search key display area 236. Base upon the used key word(s) as displayed in the used search key display area 236, for each of the selected information sources as displayed in the information source display area 230, a number of searched items is shown in the number of hits display area 232. For each of the selected information sources, a cost is also displayed in the fee display area. Using this example, for the web magazine information source, assuming that the cost of the search is 1 yen per hit, since there are twenty-eight hits, the fee for this category is 28 yens. Similarly, for the free web site information source, assuming that the cost of the search is 10 yen per hit, since there are eighty-three hits, the fee for this category is 830 yens. For the membership web site information source, assuming that the cost of the search is 100 yen per hit, since there are twelve hits, the fee for this category is 1200 yens. For the specialized web site information source, assuming that the cost of the search is 200 yen per hit, since there are three hits, the fee for this category is 600 yens. The total amounts of the above hits and the above fees are also displayed. In an alternative user interface, the combined fees of the insurance premium and the search fee are displayed.

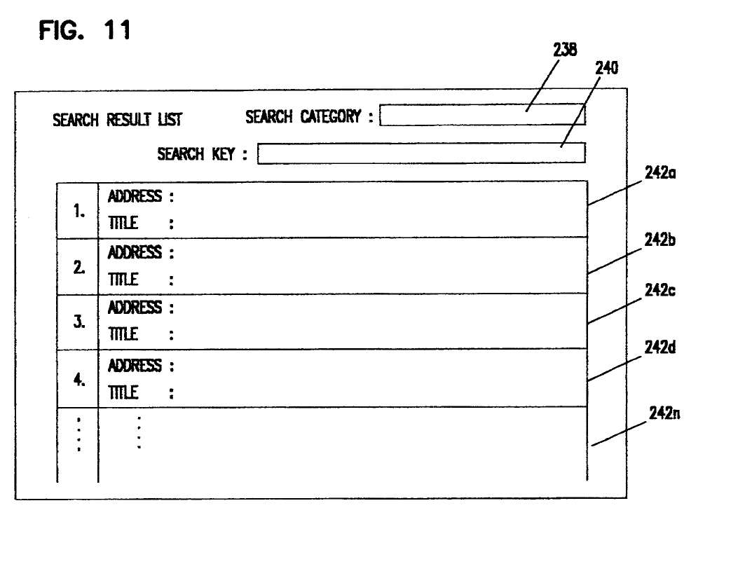

Referring to FIG. 11, a diagram illustrates an exemplary user interface for the search result list of one preferred embodiment of the Internet-related damage insurance transaction system according to the current invention. The exemplary user interface includes an information source area 238, a used search key area 240, and search result display areas 242a through 242n. Each of the search result display areas 242a through 242n displays a web corresponding address as well as a title. Either of these text lines is selectively clicked to get further information.

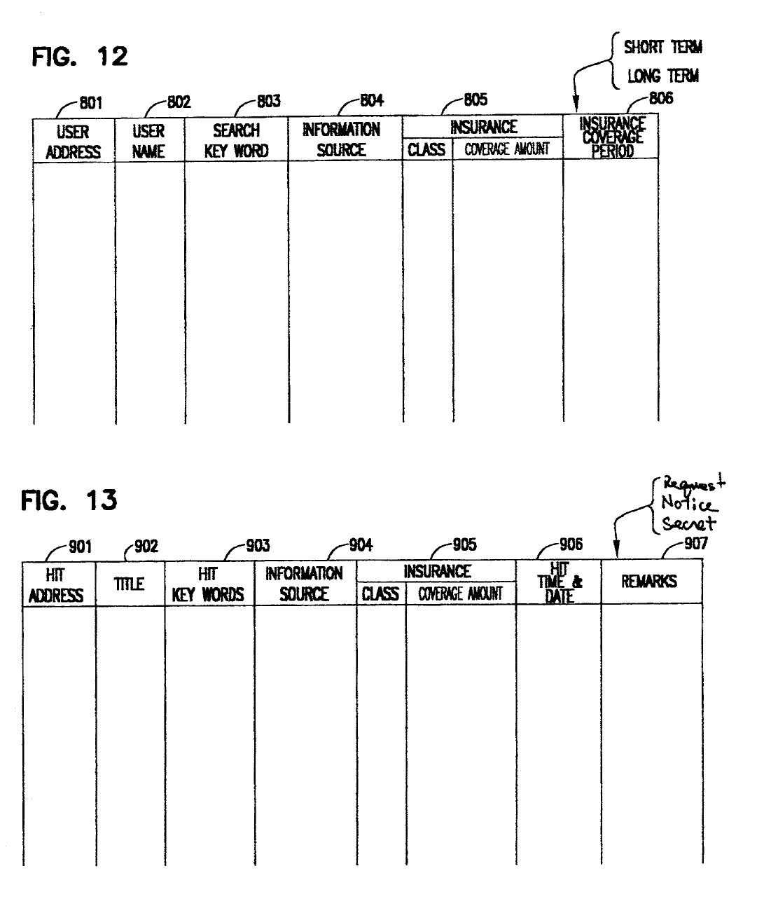

Referring to FIG. 12, a diagram illustrates an exemplary user management table for one preferred embodiment of the Internet-related damage insurance transaction system according to the current invention. The exemplary user management table is used at either at a search site and or at an insurance provider site to manage the users in the above described insurance transaction system. The exemplary user management table includes a user address entry 801 for storing a user web address, a user name entry 802 for storing a user name, a search key word entry 803 for storing specified key words, an information source entry 804 for storing information sources used for the specified key words, an insurance information entry 805 for storing insurance information for the search and an insurance coverage period entry 806 for storing coverage information. The insurance information entry 805 is further divided into an insurance class entry and an insurance coverage amount.

Referring to FIG. 13, a diagram illustrates an exemplary individual user table for one preferred embodiment of the Internet-related damage insurance transaction system according to the current invention. The exemplary individual user table includes information on the conducted searches for a particular individual user. The exemplary individual user table contains a hit address entry 901 for storing a web address, a title entry 902 for storing a title, a hit key word entry 903 for storing a key word or words found in the hit site, an information source entry 904 for storing a information source where the hit is found, an insurance information entry 905 for storing the corresponding insurance information, a hit time/date entry 906 for storing the time/date the hit was recorded and a remarks entry 907 for storing remarks. The insurance information entry 905 is further divided into an insurance class entry and an insurance coverage amount. The remarks are inputted by the user and indicate some significance of the content information. The significance includes secrecy, requested item and so on.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of selling and buying insurance for damages to computer files caused by the Internet-related activities, comprising:
selecting at least one activity from a set of predetermined activities on the Internet for insurance coverage, the predetermined activities bearing a certain risk of causing damage to the computer files;
selecting an insurance coverage amount from a set of predetermined amounts for the selected Internet activities;
calculating a premium amount for an insurance purchaser based upon at least a combination of the selected insurance coverage amount and the selected Internet activities; and
submitting the premium to an insurance provider.

2. The method of selling and buying insurance for damages to computer files caused by the Internet activities according to claim 1 wherein the predetermined activities on the Internet include down-loading a file from a web site, opening e-mail, opening e-mail attachments, searching information from web sites and copying a file from a secondary storage medium, any one of the predetermined activities inducing a transfer of an undesirable destructive computer virus.

3. The method of selling and buying insurance for damages to computer files caused by the Internet activities according to claim 2 wherein the secondary storage medium includes a floppy disk, a zip disk and a CD.

4. The method of selling and buying insurance for damages to computer files caused by the Internet activities according to claim 1 further comprising:
selecting a discount feature from a set of predetermined conditions, the predetermined conditions including a maximal number of performing the selected Internet activities, an existing anti-virus program and an existing firewall; and
adjusting the premium amount based upon the selected discount feature.

5. The method of selling and buying insurance for damages to computer files caused by the Internet activities according to claim 1 further comprising:
reporting a damage caused by the selected Internet activities to the insurance provider; and
making a claim for the damage for reimbursement.

6. The method of selling and buying insurance for damages to computer files caused by the Internet activities according to claim 5 wherein the premium is periodically adjusted based upon a number of the insurance purchasers and a number of the claims.

7. The method of selling and buying insurance for damages to computer files caused by the Internet activities according to claim 5 further comprising:
providing service from the insurance provider to repair the damage to the computer files.

8. The method of selling and buying insurance for damages to computer files caused by the Internet activities according to claim 5 further comprising:
making a monetary payment to the insurance purchaser for restoring the damage to the computer files.

9. A system for selling and buying insurance for damages to computer files caused by the Internet activities, comprising:
a first user input module for selecting at least one activity from a set of predetermined activities on the Internet for insurance coverage, the predetermined activities bearing a certain risk of causing damage to the computer files;
a second user input module for selecting an insurance coverage amount from a set of predetermined amounts for the selected Internet activities;
a processing module connected to said first user input module and said second user input module for calculating a premium amount for an insurance purchaser based upon at least a combination of the selected insurance coverage amount and the selected Internet activities; and
a premium payment module for connected to said processing module for submitting the premium to an insurance provider.

10. The system for selling and buying insurance for damages to computer files caused by the Internet activities according to claim 9 wherein said predetermined activities on the Internet include down-loading a file from a web site, opening e-mail, opening e-mail attachments, and searching information from web sites, any one of the predetermined activities inducing a transfer of an undesirable destructive computer virus.

11. The system for selling and buying insurance for damages to computer files caused by the Internet activities according to claim 9 further comprising a secondary storage module for storing information on a secondary storage medium, said predetermined activities including copying a file from said secondary storage medium.

12. The system for selling and buying insurance for damages to computer files caused by the Internet activities according to claim 11 wherein said secondary storage medium includes a floppy disk, a zip disk and a CD.

13. The system for selling and buying insurance for damages to computer files caused by the Internet activities according to claim 9 further comprising:
a third user input module connected to said processing module for selecting a discount feature from a set of predetermined conditions, the predetermined conditions including a maximal number of performing the selected Internet activities, an existing anti-virus program and an existing firewall, said processing module adjusting the premium amount based upon the selected discount feature.

14. The system for selling and buying insurance for damages to computer files caused by the Internet activities according to claim 9 further comprising:
a fourth user input module connected to said processing module for reporting a damage caused by the selected Internet activities to the insurance provider and for making a claim for the damage for reimbursement.

15. The system for selling and buying insurance for damages to computer files caused by the Internet activities according to claim 14 wherein said processing module periodically adjusts the premium based upon a number of the insurance purchasers and a number of the claims.
